(19) United States
(12) Patent Application Publication
(10) Pub. No.: US 2023/0214707 A1
(43) Pub. Date: Jul. 6, 2023

(54) ENHANCED LEXICON-BASED CLASSIFIER MODELS WITH TUNABLE ERROR-RATE TRADEOFFS

(71) Applicant: MICROSOFT TECHNOLOGY LICENSING, LLC, Redmond, WA (US)

(72) Inventors: Mohit SEWAK, Pune (IN); Ravi Kiran Reddy POLURI, Sammamish, WA (US)

(21) Appl. No.: 17/566,898

(22) Filed: Dec. 31, 2021

(51) Int. Cl. G06N 20/00; G06F 16/28

(52) U.S. Cl. CPC G06N 20/00; G06F 16/285

(57) ABSTRACT

The disclosure is directed to systems, methods, and computer storage media, for, among other things, generating, training, and tuning lexicon-based classifier models. The models may be employed in various compliance enforcement applications and/or tasks. The tradeoff between the model's false positive error rate (FPR) and the model's false negative rate (FNR) may be “tuned” via a balance parameter supplied by the user. The classifier model may classify content (e.g., text records) as either belonging to a “positive” class or a “negative” class. The positive class may be associated with non-compliance, while the negative class may be associated with compliance (or vice-versa). In some embodiments, the classifier model may be a probabilistic probability model that provides a probability (or degree of belief) that the content is associated with the positive and/or negative class.

### BACKGROUND

Numerous industries, governmental agencies, and other parties are often tasked with ensuring that their processes, procedures, data-communications, and agents conform to one or more regulations, rules, standards, and/or heuristics that ensure compliance with best practices in the associated activity domain. The general act of ensuring such conformity-in-action is often referred to as compliance enforcement. Due to the sheer volume of content associated with transactions, communications, and other activities that must be monitored to ensure compliance, as well as increasing complexity, automated monitoring methods are often the only tractable solution for at least partially effective compliance enforcement. Such automated methods often rely on a classifier model, or a variant thereof. However, the conventional technologies using classifier models are prone to numerous deficiencies that inhibit the effectiveness of compliance enforcement in many applications.

### SUMMARY

Various aspects of the technology described herein are generally directed to systems, methods, and computer storage media, for, among other things, generating, training, and tuning lexicon-based, computing classifier models. The models may be employed in various compliance enforcement computing applications and/or tasks. The tradeoff between the model's false positive error rate (FPR) and the model's false negative rate (FNR) may be “tuned” via a balance parameter supplied by the user. The classifier model may classify content (e.g., text records) as either belonging to a “positive” class or a “negative” class. The positive class may be associated with non-compliance, while the negative class may be associated with compliance (or vice-versa). In some embodiments, the classifier model may be a probabilistic probability model that provides a probability (or degree of belief) that the content is associated with the positive and/or negative class.

The lexicon-based classifier may be generated by employing a labeled dataset that includes text records. The text records are labeled as belonging to either the positive or negative class. A labeled dataset is segmented into training data and test (or validation) data. The training data is further segmented into lexicon training data and scoring threshold data. The lexicon training data is further segmented into positive lexicon training data and negative lexicon training data. The positive and negative lexicon training data are employed to generate a positive lexicon and a negative lexicon. The positive and negative lexicons may be weighted lexicons. The positive and negative lexicons are segmented into a pure positive lexicon, a pure negative lexicon, and an uncertain lexicon. The uncertain lexicon may include the intersection of the positive and negative lexicons. The pure positive lexicon may include the set difference between the positive lexicon and the negative lexicon, while the pure negative lexicon may include the set difference between the negative lexicon and the positive lexicon.

The pure positive lexicon, the pure negative lexicon, and the uncertain lexicon are employed to generate three corresponding lexicon-based classifier models: a pure positive model (based on the pure positive lexicon), a pure negative model (based on the pure negative lexicon), and an uncertain model (based on the uncertain lexicon). Each of the three models are enabled to output, based on an input text record, one or more scores that indicate a propensity of the text record as being associated with a positive, negative, or uncertain “sentiment.” An integrated model is generated to include the three sub-models (e.g., the pure positive model, the pure negative model, and the uncertain model).

More particularly, one embodiment may include receiving text-based content. An integrated classifier may be employed to classify the text-based content as belonging to a positive class of the integrated classifier model. The integrated classifier model may include a first sub-model based on a first lexicon, a second sub-model based on a second lexicon, and a third sub-model based on a third lexicon. The first lexicon may include a first plurality of strings that are included in a first plurality of training records that are labeled as belonging to the positive class of the classifier model. The second lexicon may include a second plurality of strings that are included in a second plurality of training records that are labeled as belonging to a negative class of the classifier model. The third lexicon may include a third plurality of strings that are included in both the first plurality of training records and the second plurality of training records. In response to classifying the text-based content as belonging to the positive class of the classifier model, one or more mitigation actions that alter subsequent transmissions of the text-based content may be performed. The one or more mitigation actions may include at least one of providing an alert that indicates the text-based content, deleting the text-based content, replacing the text-based content, or quarantining the text-based content.

In some embodiments, a balance parameter may be received. The balance parameter may indicate a target (e.g., a predetermined and/or desired) tradeoff between a false positive error rate (FPR) of the classifier model and a false negative error rate (FNR) of the classifier model. The balance parameter may be employed to update the classifier model such that the updated classifier model, when benchmarked against a third plurality of training records, exhibits the target tradeoff between the FPR of the classifier model and the FNR of the classifier. The updated classifier model may be employed to classify the text-based content as belonging to a positive class of the classifier model.

Other embodiments may include generating a first sub-model of the classifier model based on a first lexicon. The first lexicon may include a first plurality of strings. The first plurality of strings may be included in a first plurality of training records. Each of the records of the first plurality of training record may include a label that indicates that the record belongs to the positive class. A second sub-model of the classifier model may be generated based on a second lexicon. The second lexicon may include a second plurality of strings. The second plurality of strings may be included in a second plurality of training records. Each record of the second plurality of records may include a label that indicates that the record belongs to a negative class of the classifier model. A third sub-model of the classifier model may be generated. Generating the third sub-model may be based on a third lexicon. The third lexicon may include a third plurality of strings. The third plurality of strings may be included in both the first plurality of training records and the second plurality of training records. The first sub-model, the second sub-model, and the third sub-model may be integrated to generate the classifier model.

In various embodiments, a fourth lexicon may be generated based on the first plurality of training records. A fifth lexicon may be based on the second plurality of training records. The first, second, and third lexicons may be generated based on the fourth lexicon and the fifth lexicon. More specifically, an intersection of the fourth and fifth lexicons may be determined. The third lexicon may be generated to include the determined intersection of the fourth and fifth lexicons. A set difference between the fourth and fifth lexicons may be determined. The first lexicon may be generated to include the determined set difference between the fourth and fifth lexicons. A set difference between the fifth and fourth lexicons may be determined. The second lexicon may be generated to include the determined set difference between the fifth and fourth lexicons.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A illustrates an enhanced classifier system 100 implementing various embodiments presented herein;

FIG. 1B illustrates an enhanced elastic layer 150 implementing various classifier models, in a manner that is consistent with the various embodiments;

FIG. 1C illustrates an enhanced integrated model 180, as generated in various embodiments;

FIG. 2 includes a flow diagram that illustrates a method for content classification and enforcing compliance for one or more regulations, in accordance to the various embodiments;

FIG. 3A includes a flow diagram that illustrates a method for generating lexicons for employment by a lexicon-based classifier model, in accordance to the various embodiments;

FIG. 3B shows a segmentation of labeled data into various datasets and lexicons, in accordance to various embodiments;

FIG. 3C shows a generation of multiple lexicons, in accordance to various embodiments;

FIG. 4 includes a flow diagram that illustrates a method for generating and training a lexicon-based classifier model, in accordance to the various embodiments;

FIG. 5 includes a flow diagram that illustrates a method for tuning a lexicon-based classifier model to a desired error-rate tradeoff, in accordance to the various embodiments; and

FIG. 6 is a block diagram of an exemplary computing environment suitable for use in implementing aspects of the technology described herein.

### DETAILED DESCRIPTION

Various aspects of the technology described herein are generally directed to systems, methods, and computer storage media, for, among other things, generating, training, and tuning lexicon-based classifier models. The models may be employed in various compliance enforcement applications and/or tasks. The tradeoff between the model's false positive error rate (FPR) and the model's false negative rate (FNR) may be “tuned” via a balance parameter supplied by the user. The classifier model may classify content (e.g., text records) as either belonging to a “positive” class or a “negative” class. The positive class may be associated with non-compliance, while the negative class may be associated with compliance (or vice-versa). In some embodiments, the classifier model may be a probabilistic probability model that provides a probability (or degree of belief) that the content is associated with the positive and/or negative class.

As used herein, the term “set” may be employed to refer to an ordered (i.e., sequential) or an unordered (i.e., non-sequential) collection of objects (or elements), such as but not limited to machines (e.g., computer devices), physical and/or logical addresses, graph nodes, graph edges, and the like. A set may include N elements, where N is any non-negative integer. That is, a set may include 0, 1, 2, 3, . . . N objects and/or elements, where N is a positive integer with no upper bound. Therefore, as used herein, a set may be a null set (i.e., an empty set), that includes no elements (e.g., N=0 for the null set). A set may include only a single element. In other embodiments, a set may include a number of elements that is significantly greater than one, two, three, or billions of elements. A set may be an infinite set or a finite set. In some embodiments, “a set of objects” that is not a null set of the objects may be interchangeably referred to as either “one or more objects” or “at least one object.” A set of objects that includes at least two of the objects may be referred to as “a plurality of objects.”

As used herein, the term “subset” is a set that is included in another set. A subset may be, but is not required to be, a proper or strict subset of the other set that the subset is included within. That is, if set B is a subset of set A, then in some embodiments, set B is a proper or strict subset of set A. In other embodiments, set B is a subset of set A, but not a proper or a strict subset of set A. For example, set A and set B may be equal sets, and set B may be referred to as a subset of set A. In such embodiments, set A may also be referred to as a subset of set B. Two sets may be disjoint sets if the intersection between the two sets is the null set.

As used herein, the term “lexicon” may refer to any set, sequence, list, array, or other such collection of character strings (e.g., natural language tokens, keywords, key-phrases, sentences, sentence fragments, paragraphs, and the like). In some embodiments, each of the character strings included in a lexicon may be in relationship with each of the other character strings included in the lexicon. The relationship between the character strings (or simply strings) may be a relationship of “classification” and/or correlation. For instance, prior to being included (or inserted) into a lexicon, each string may have been associated (or correlated) with a “class” or “category” that is associated with the lexicon.

### Overview of Technical Problems, Technical Solutions, and Technological Improvements

As described previously, in many applications, such as compliance enforcement, the sheer volume of content associated with transactions communications and other processes that must be monitored to ensure compliance, necessitates using automated technology in order to provide at least partially effective compliance enforcement. Such automated technologies often rely on a classifier model, or a variant thereof. In general, a classifier model analyzes content (e.g., text-based content), and classifies the content as being associated with one or more categories, types, classes, or other generalized “buckets” (or bins).

Conventional classifier models are often trained with well-known supervised deep learning methods that require substantial volumes of high-quality labeled training data. Such training may result in a “black box” model. In a black box model, a user may lack access to the internal “logic” (e.g., pattern-recognition techniques) of the trained model. Therefore such black box models are not preferred, as the user may not have an ability to understand the limitations of the model and under what conditions the model may provide widely inaccurate and/or mixed results. That is, when the model has been trained via deep learning, the user may lack an understanding of the model's performance and reliability. Additionally, the performance and reliability of the model may be heavily dependent on the volume and quality of the labeled training data. Conventional classifier models may be substantially biased “towards” or “away-from” one or more classes or categories depending on the distribution and quality of the labels of the training data. For example, if not enough training samples for a particular class are provided in the training data, learning a distinct “pattern” associated with the class may be difficult. Furthermore, if the learned “patterns” (encoded in the model's vector space) between two or more classes are not sufficiently separated in the vector space, then the model may not provide sufficient distinction between “similar but not equivalent” classes. That is, conventional classifier models may be difficult to train when involving sensitive classes or categories.

Type I (e.g., false positive (FP)) errors and Type II (e.g., false negative (FN)) errors are inherent to any classifier model. Also inherent to classifier models is a tradeoff between the model's FP error rate (FPR) and FN error rate (FNR). That is, for most models, decreasing the FPR may be performed only at the expense of an increase of the model's FNR (and vice-versa). Models with low FPR may be associated with high reliance, while models with low FNR may be associated with high performance (e.g., recall and accuracy). Many conventional models are designed with a fixed (or “hardwired”) tradeoff between reliance and performance. Due to the black box nature of conventional models, the user may not be equipped to understand the nature of the underlying FPR and FNR, nor the tradeoff between the two error rates.

Some compliance applications cannot tolerate high FNR (e.g., reliability-compliance for commercial aircraft components), while other compliance applications cannot tolerate high FPR (e.g., data-filtering compliance, where the filtering of “rare” or “important” events is not acceptable). Due to the black box nature of conventional classifier models, users may not be enabled to tailor the model to the needs of their compliance enforcement task and the nature of the data being classified. Accordingly, conventional classifier models may inhibit the effectiveness of compliance enforcement in many applications.

Embodiments of this disclosure solve these and other technical deficiencies by providing embodiments of technology for generating, training, and tuning lexicon-based classifier models. In particular, as described herein, the tradeoff between the model's FPR and FNR may be “tuned” via a balance parameter supplied by the user, and content may be classified content as either belonging to a “positive” class or a “negative” class. In one embodiment, the positive class may be associated with non-compliance, while the negative class may be associated with compliance (or vice-versa). In some embodiments, the classifier model may be a probabilistic probability model that provides a probability (or degree of belief) that the content is associated with the positive and/or negative class.

The association and/or correlation with the classification may be a “probabilistic” classification and/or correlation. That is, the included string may have an associated probability (or “weight”) as being associated and/or correlated with a class or category. In some embodiments, the weight for a string may indicate a probability that the string is associated and/or correlated with the class or category. As discussed below, the class and/or category may be considered a trigger condition (or simply a condition). In at least one embodiment, the weight may indicate a correlation weight (or correlation coefficient) with the class or category. In some embodiments, the weight associated with a string may be any real value within the closed interval: [0,1]. In at least one embodiment, the weight associated with a string may be any real value within the closed interval: [−1,1]. A positive weight may indicate that the string is “positively” associated (or correlated) with the class or category. A negative weight may indicate that the string is “negatively” associated (or correlated) with the class or category. In some embodiments, the weight for a string may be interpreted as a “degree of belief” (e.g., in a Bayesian-sense) that the string is associated with the category, class, and/or condition. As discussed below, the weight (or probability) of the classification may be included in the lexicon as metadata associated with the included string. Lexicons that employ weights may be referred to as weighted lexicons. A lexicon that does not include associated weights for its string entries may be referred to as a glossary lexicon.

In some embodiments, each string included in a lexicon may have an associated weight that is greater (or less) than a threshold weight for the lexicon. The threshold weight for a lexicon may be any value within the closed interval: [0,1]. For example, a string with an associated weight of 0.0 may be associated with absolute certain belief that the string is not associated with the class and/or condition, while another string with an associated weight of 1.0 may be associated with an absolute certain belied that the string is associated with the class and/or condition. If another string is associated with a weight of 0.5 may be associated with a 50% degree of belief that the string is associated with the class and/or condition. In embodiments that employ negative weights, the threshold weight for a lexicon may be any value within the closed interval: [−1,1]. The degrees of belief interpretation of weights may apply to negative weight, as well as positive weights.

As noted above, a lexicon may be associated with a category or classification. In some embodiments, a binary classification (e.g., a classification that includes two possible classifications: a “positive” class and a “negative” class) is employed. These embodiments may employ at least two lexicons: a “positive” lexicon” and a “negative” lexicon. The strings included in the positive lexicon may have been “positively” associated (or correlated) with the positive class. Likewise, the strings included in the negative lexicon may have been “positively” associated (or correlated) with the negative class. In some embodiments, the strings included in the negative lexicon may have been “negatively” associated (or correlated) with the positive class and/or the strings included in the negative lexicon may have been “negatively” associated (or correlated) with the positive class.

In at least one embodiment, the class and/or category associated with a positive lexicon may be a “positive” sentiment and the class and/or category associated with a negative lexicon may be a “negative” sentiment. Some embodiments may be directed towards “compliance enforcement.” In such embodiments, the class and/or category associated with a positive lexicon may be a failure condition associated with complying with one or more regulations and/or heuristics associated with a compliance condition. The class and/or category associated with a negative lexicon may be a success condition associated with complying with one or more regulations and/or heuristics associated with a compliance condition. In other embodiments, the classifications of the positive and negative lexicons may be inverted. That is, the positive lexicon may be associated with successfully complying with the regulation and/or heuristic, while the negative lexicon is associated with failing to comply with the regulation and/or heuristic. Thus, it may be said that a lexicon is associated with a “condition.” For instance, a positive lexicon (and its included strings) may be associated with a first condition (e.g., failing a compliance test), and a negative lexicon (and its included strings) may be associated with a second condition (e.g., not failing a compliance test).

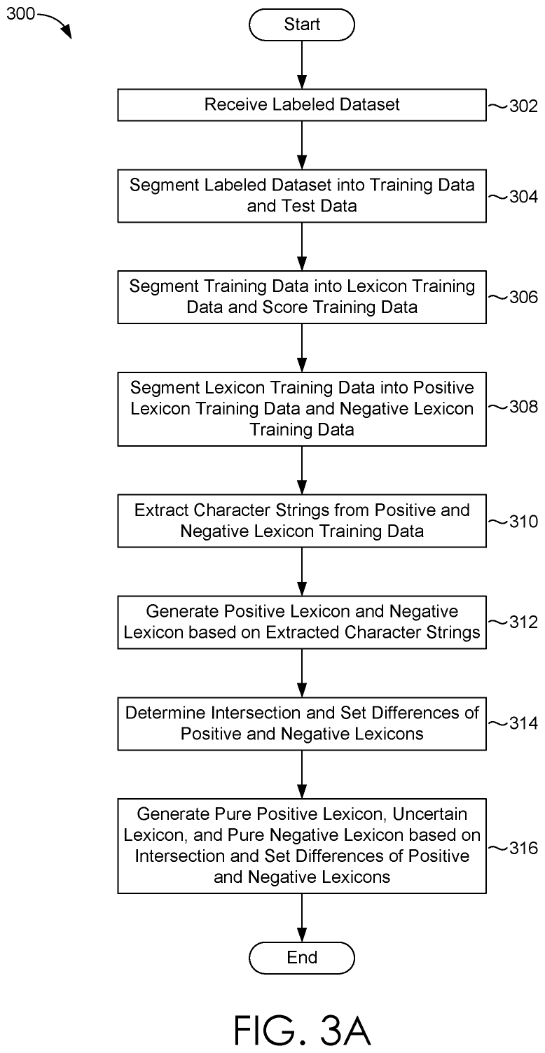

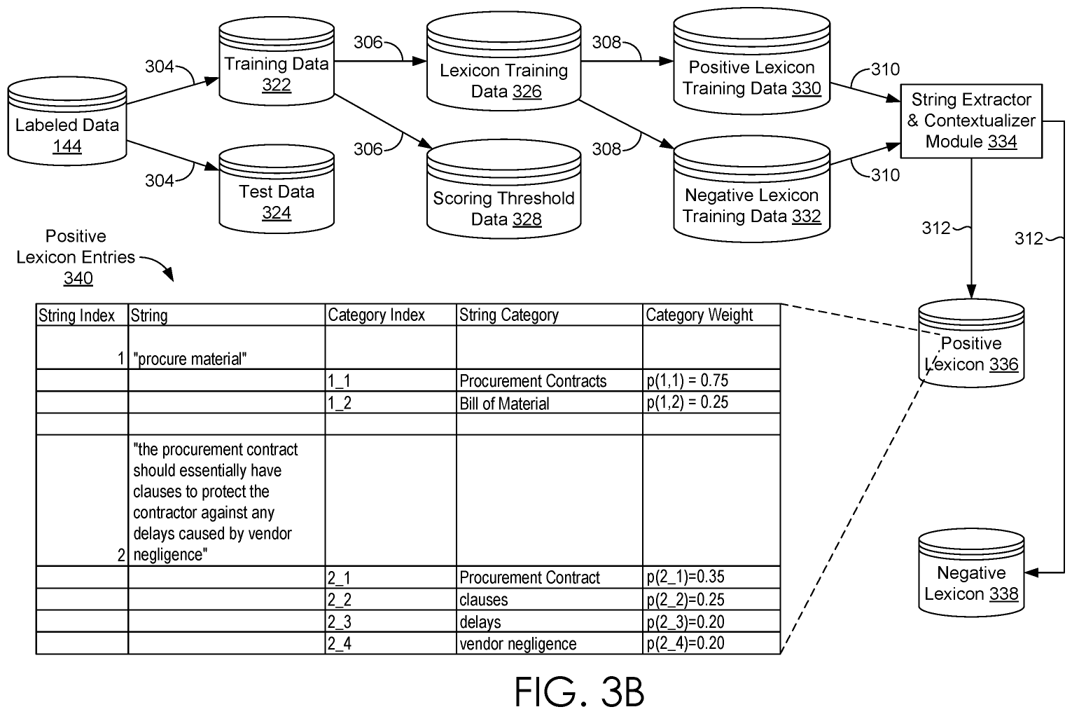

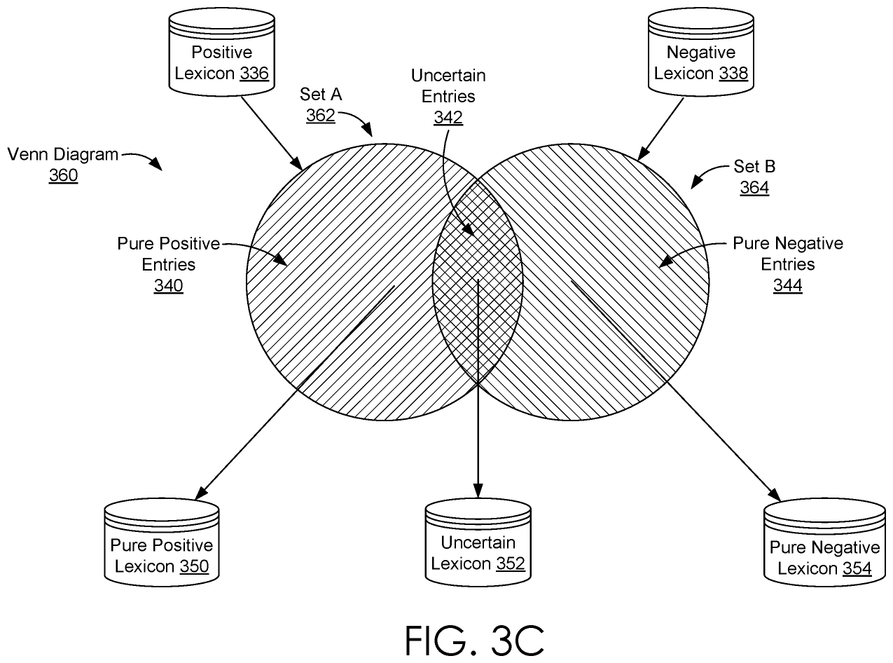

The semantic meaning, definition, context, and/or category of natural language words, phrases, sentence fragments, and/or sentences is often overloaded. As such, a string included in a lexicon may be associated and/or correlated with one or more contexts and/or classes. A separate weight for such a string may be assigned to each of the one or more contexts and/or categories. As an example, the string “procure material” may be associated with the category or context “procurement contracts,” as well as the category or context “bill of material.” Each of the categories and/or contexts may be referred to as contextual labels. For example, the categories “procurement contracts” and “bill of material” may be referred to as separate contextual labels for the string “procure material.” A separate weight may be assigned to each of the two contexts or categories (e.g., contextual categories). For example, the weight for the “procurement contracts” context may be 0.75 and the weight for the “bill of material” context may be 0.25. If the string “procure material” is included in a positive lexicon, then the employment of the string, in the context of “procurement contracts,” may be associated with the “positive” condition (associated with the positive lexicon) with a 75% probability (or degree of belief). Likewise, when the string is employed in the “bill of material” context, the string may be associated with the “positive” condition (associated with the positive lexicon) with a 25% probability (or degree of belief). Note that the same string may be included in both the positive and negative lexicons, with the same, similar, separate, or dissimilar categories or contexts, as well as the same, similar, separate, or dissimilar weights. Thus, an entry (e.g., a string) in a weighted lexicon may be associated with one or more contexts (or categories) and a weight for each of the one or more contexts (or categories). Non-limiting example entries in a weighted lexicon are shown in positive lexicon entries 340 of FIG. 3B.

As noted above, in some lexicons, metadata is associated with one of more of the included character strings. The metadata associated with a string entry may include the one or more contexts (or categories), as well as the weights for the one or more contexts (or categories). Other metadata types may be associated with the lexicon's strings, such as but not limited to string embeddings (e.g., vector embeddings representing the string and its context). For example, the string “lay” may be included in a lexicon and its metadata includes multiple contexts, a separate weight for each context, and a separate string embedding for each context. Lexicons that included embedding metadata may be referred to as embedding lexicons. Some lexicons may include graph metadata. For example, a graph-based methods may be applied to a corpus of text records to generate knowledge graphs (e.g., a semantic graph) for a string. Lexicons that include graphical metadata may be referred to as graph lexicons. A lexicon may be a hybrid (or combination) lexicon. For example, a lexicon may simultaneously be a weighted lexicon, an embedding lexicon, and a graph lexicon.

The lexicon-based classifier may be generated by employing a labeled dataset that includes text records. The text records are labeled as belonging to either the positive or negative class. A labeled dataset is segmented into training data and test (or validation) data. The training data is further segmented into lexicon training data and scoring threshold data. The lexicon training data is further segmented into positive lexicon training data and negative lexicon training data. The positive and negative lexicon training data are employed to generate a positive lexicon and a negative lexicon. The positive and negative lexicons may be weighted lexicons. The positive and negative lexicons are segmented into a pure positive lexicon, a pure negative lexicon, and an uncertain lexicon. The uncertain lexicon may include the intersection of the positive and negative lexicons. The pure positive lexicon may include the set difference between the positive lexicon and the negative lexicon, while the pure negative lexicon may include the set difference between the negative lexicon and the positive lexicon.

The pure positive lexicon, the pure negative lexicon, and the uncertain lexicon are employed to generate three corresponding lexicon-based classifier models: a pure positive model (based on the pure positive lexicon), a pure negative model (based on the pure negative lexicon), and an uncertain model (based on the uncertain lexicon). Each of the three models are enabled to output, based on an input text record, one or more scores that indicate a propensity of the text record as being associated with a positive, negative, or uncertain “sentiment.” An integrated model is generated to include the three sub-models (e.g., the pure positive model, the pure negative model, and the uncertain model). When a novel text record is received by the integrated model, one or more of the sub-models may be triggered. The one or more scores generated by the one or more triggered sub-models may be combined to generate an overall (or integrated) score for the text record.

To train the integrated model (and its sub-models), the labeled lexicon training data may be employed. One or more different scoring algorithms may be employed to generate one or more relevancy scores for each text record in the lexicon training data. Each of the one or more relevancy scores for a text record may indicate a relevancy for one of the lexicons (e.g., the pure positive lexicon, the pure negative lexicon, and the uncertain lexicon) to the text record. The relevancy scores (and the labels included in the lexicon training data) are employed to determine a discrimination function that discriminates between positive and negative samples of the text records. In some embodiments, a hierarchical scoring algorithm is employed to generate the discrimination function. In other embodiments, an ensemble scoring algorithm is employed to generate the discrimination function.

A user provided balance parameter may be employed to tune the trained classifier model such that the tuned model has a desired tradeoff (or balance as indicated by the balance parameter) between the model's FPR and FNR. In the tuning stage, one or more scoring threshold parameters (e.g., thresholds for the discrimination function) are iteratively determined. The scoring threshold data may be employed to determine the scoring threshold parameters. Because the scoring threshold data is labeled, the corresponding FPR and FNR may be estimated for a particular selection of scoring threshold parameters. The parameters may be adjusted to achieve the desired tradeoff between the model's FPR and FNR. The trained and tuned model may be validated via the labeled test (or validation) data. Once generated, trained, tuned, and validated, the lexicon-based classifier model may be deployed in one or more compliance enforcement scenarios or applications.

### Environments for Content Classification, Compliance Enforcement, and Model Training

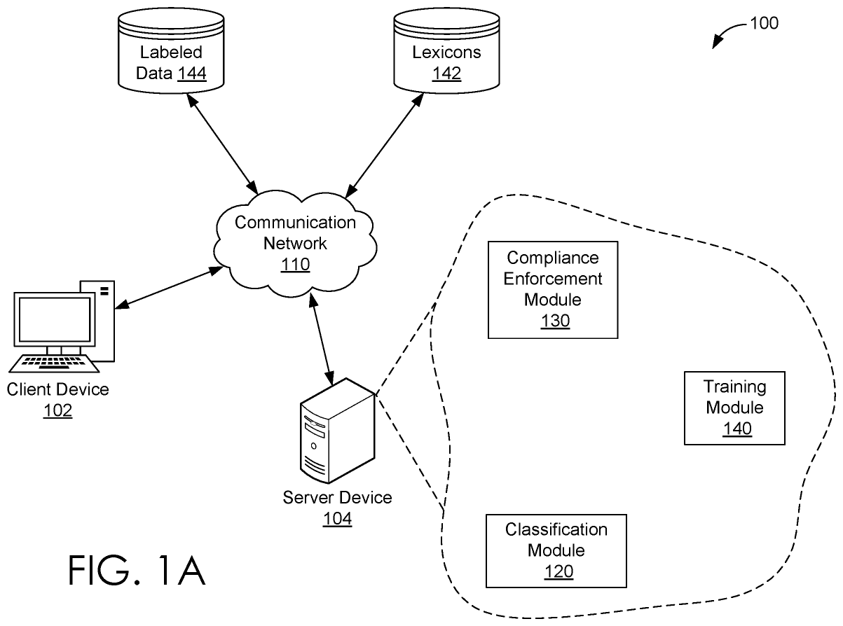

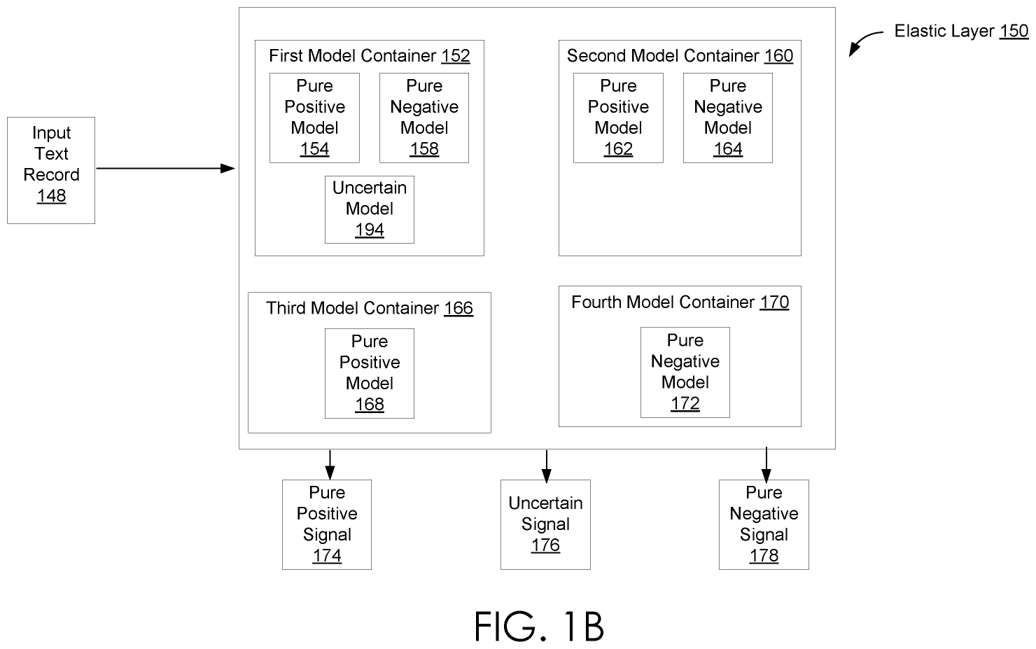

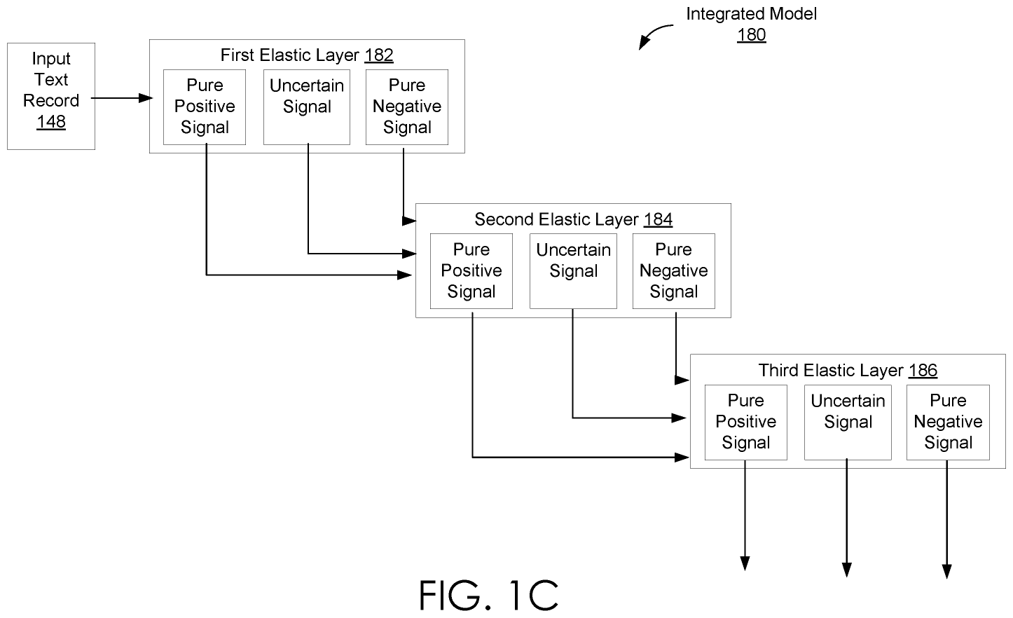

FIG. 1A illustrates an enhanced classifier system 100 implementing various embodiments presented herein. Classifier system 100 is enabled to classify a data object (e.g., data that encodes natural language content, video content, audio content, multimedia content, or the like) into at least one of two (e.g., binary) categories or classifications (e.g., input textual content may be classified as belonging to a “positive” class or a “negative” class). System 100 also enables the training of one or more models employed to classify such data objects via a binary classification paradigm (e.g., the positive class and the negative class). The training of the one or more models may be based on labeled data 144. In various embodiments, at least one of the one or more models may be a classifier model for one or more classes or categories (e.g., the “positive” class and the “negative” class). At least one of the one or more classifier models may be a binary classification model. At least one of the one or more binary classifier models may be a lexicon-based classifier model. As such, one or more lexicons (e.g., lexicons 142) may be associated with the one or more lexicon-based classifier models.

In some embodiments, the classification of an input data object may be deterministic. That is, the one or more classifier (or classification) models may deterministically classify the object into a binary classification, e.g., the object is classified as belonging to exactly one of the positive class or the negative class. In other embodiments, the classification may be a probabilistic classification, e.g., the classifier model may output that the object has a 65% chance of belonging to the positive class and a 35% chance of belonging to the negative class. Such models may be referred to as probabilistic models. Note that the classifications in the binary (e.g., the sum of the probabilities for the positive and negative classes) is equivalent to 100%.

In various embodiments, the classification of an input object may be employed in the service of compliance monitoring and/or enforcement. The binary classification may be directed to one or more compliance regulations. A positive classification of the input object may indicate that the object fails to satisfy one or more compliance regulations (e.g., regulations, heuristics, or rules related to network security, data privacy, and the like). In some embodiments, a positive classification of the object may indicate that the input object is non-compliant with respect to at least one of the one or more regulations. In other embodiments, a negative classification of the object may indicate that the input object in non-compliant with respect to at least one of the one or more regulations. If the object is non-compliant, system 100 may invoke one or more compliance-enforcement interventions and/or mitigations (e.g., terminate a transmission of the object, quarantine and/or sandboxing of the object, encrypting the object, redacting the object, or the like). Thus, in some embodiments, system 100 may be a compliance enforcement system. Some embodiments may enforce a plurality of compliance regulations. In such models, one or more classifier models may be implemented for each compliance regulation of the plurality of compliance regulations. Although the following discussion is directed towards a single binary classification, it should be understand that a plurality of binary classifier models may be implemented in a similar manner to address a plurality of compliance regulations.

Classifier system 100 may include at least a client computing device 102 and a server computing device 104, in communication via a communication network 110. The client computing device 102 can provide the data object to be classified to the server computing device 104, via the communication network 110. The server computing device 104 may implement various modules to train and implement the one or more classifier models. For instance, server device 102 may implement a classification module 120, a compliance-enforcement module 130, and a training module 140. Classification module 120 may implement the one or more classifier models. Compliance-enforcement module 130 may implement the one or more compliance-enforcement interventions based on the output of the classification module 120. Training module 140 may train the one or more classifier models by employing labeled data 144. The one or more lexicons that the classifier models employ may be included in lexicons 142. Although a client/server architecture is shown in FIG. 1A, the embodiments are not limited to such architectures. For example, client computing device 102 may implement at least one of the classification module 120, the compliance enforcement module 130, or the training module 140, obviating the offloading of classification, compliance-enforcement, and training tasks to server devices.

Communication network 110 may be a general or specific communication network and may directly and/or indirectly communicatively coupled to client computing device 102 and server computing device 104. Communication network 110 may be any communication network, including virtually any wired and/or wireless communication technologies, wired and/or wireless communication protocols, and the like. Communication network 110 may be virtually any communication network that communicatively couples a plurality of computing devices and storage devices in such a way as to computing devices to exchange information via communication network 110.

Type I (e.g., false positive (FP)) errors and Type II (e.g., false negative (FN)) errors are inherent in any binary classifier model. There is often a negative correlation between a model's FP error rate and the model's FN error rate. That is, there may be tradeoff between any model's FP and FN rates. The recall metric (or recall speed) of a classifier model, which is sensitive to the model's FN rate, is often employed to characterize the precision of the model. A lower FP rate may indicate a higher accuracy for the model, while a lower FN rate may indicate a higher recall (or precision) for the model. Thus, there may exist a negative correlation (or tradeoff) between a model's FP rate (FPR) and the model's recall capability. In the various embodiments, a user (e.g., a user of client device 102) may “tune” the tradeoff between a model's FPR and recall, via a “balance parameter.” The balance parameter may indicate the “balance” between the model's FPR and recall. For example, a balance parameter may indicate at least one of a maximum FPR, a maximum FNR, a minimum recall, or the like for a model. A user or a system administrator may provide the balance parameter to the server device 104. The training module 140 may “tune” the one or more trained classifier models based on the balance parameter. The “tuned” classifier model may classify any received input objects, in accordance with the FPR/recall balance indicated by the balance parameter.

### Elastic Lavers and Adaptive Hierarchies for Classification Models

In the various embodiments, classifier models may be modular and combined in various ways. As discussed below, a classifier model may be based on one or more lexicons. One or more lexicon-based classifier models may be bundled (or combined) into a model container (or model droplet). One or more model containers may be bundled (or combined) into an elastic model layer. One or more elastic layers may be bundled (combined and/or integrated) into an adaptive hierarchy of models (e.g., an integrated model). As discussed below, a classifier model based on a “pure positive lexicon” (e.g., pure positive lexicon 350 of FIG. 3C) may be referred to as a pure positive classifier model. A classifier model based on a “pure negative lexicon” (e.g., pure negative lexicon 354 of FIG. 3C) may be referred to as a pure negative classifier model. A classifier model based on an “uncertain lexicon” (e.g., uncertain lexicon 352 of FIG. 3C) may be referred to as an uncertain classifier model. Because the pure positive, pure negative, and uncertain classifier models may be combined in a modular fashion, these classifier models may be referred to as sub-models. The modularity of the models, and the ability to combine them into model containers, elastic layers, and integrated models enables the generation of broader and/or more generalizable models. The modularity (and nesting) of the integrated models, elastic layers, model containers, and sub-models provides enhanced performance and a greater ability to control the tradeoffs in false positive and false negative error rates.

FIG. 1B illustrates an enhanced elastic layer 150 implementing various classifier models, in a manner that is consistent with the various embodiments. Elastic layer 150 may include one or more container models (or container droplets). In the non-limiting embodiment shown in FIG. 1B, elastic layer 150 includes four model containers: first model container 152, second model container 160, third model container 166, and fourth model container 170. Each model container may include one or more classifier models (sub-models). Each of the one of more classifier sub-models may be associated with one or more separate lexicons. In other embodiments, elastic layer 150 may include fewer or lesser than four model containers.

Note the nested structure of the elements: one or more elastic layers may be nested within an integrated model, one or more model containers (or model droplets) may be nested within an elastic layer, and one or more lexicon-based classifier models may be nested within a model container. Each layer of nesting may be directed towards greater and greater specificity, with regards to the categories (or classes) that are being classified. As discussed below, the various nested structures or elements (e.g., integrated models, elastic layers, model containers, and lexicon-based classifier models (sub-models) may be “wired” together in any possible configuration. For instance, one or more outputs of a model container may be “piped” into the inputs of one or more other model containers. In some embodiments, the output of one or more model containers may be combined in various ways to generate an output of an elastic layer that includes the model containers. Thus, within an elastic layer, the nested model containers may be arranged in a hierarchical structure of model containers. Likewise, one or more inputs of an elastic layer may be “piped” into the inputs of one or more elastic containers. The outputs of the one or more elastic layers may be combined in various ways to generate an output for the integrated model. Thus, within an integrated model, the nested elastic layers may be arranged in a hierarchical structure of elastic layers.

An integrated model may be directed towards a broad classification schema (or topic). Each of the elastic layers included in an integrated model (or adaptive hierarchy) may be directed towards a separate specific sub-topic of the topic of the integrated model. Each model container included in an elastic layer may be directed towards a separate specific sub-sub-topic of the sub-topic of the elastic layer. For instance, in one non-limiting example, the elastic layer 150 may be directed towards the detection of offensive content within an input text record 148. The first model container 152 may be directed towards the detection of profanity with the input text record and the second model container 160 may be directed towards the detection of harassment-related content with the input text record 148. The third model container 166 may be directed towards the detection of content deemed inappropriate for a first population of users within the input text record 148 and the fourth model container 170 may be directed towards the detection of content deemed inappropriate for a second population of users within the input text record 148. Each of the sub-models (e.g., lexicon-based classifier models) may be specialized to an even greater degree than the model container it is nested within.

In the non-limiting embodiment shown in FIG. 1B, the first model container 152 includes a pure positive model 154, and uncertain model 194, and a pure model 158. Each of these sub-models may be associated with one or more lexicons, which are directed towards the topic (e.g., a sub-sub topic) associated with the first model container 152. Second model container 160 may include a different combination of sub-models (e.g., a pure positive model 162 and a pure negative model 164), where these sub-models are associated with different and/or separate lexicons than those of the first model container 152. The third model 166 may include a pure positive model 168 and the fourth model container 170 may include a pure negative model 172. In other embodiments, each of the model containers may include fewer or more lexicon-based classifier models, and/or other combinations of lexicon-based sub-models.

As discussed throughout, output scores from each of the sub-models within a model container may be combined in various ways to generate one or more output signals for the model container. The outputs from the various model containers may be combined in various ways to generate one or more outputs for the elastic layer 150. In some embodiments, elastic layer 150 may include three separate output signals: a pure positive signal 174, an uncertain signals 176, and a pure negative signal 178.

FIG. 1C illustrates an enhanced integrated model 180, as generated in various embodiments. Integrated model 180 include one or more elastic layers. In the non-limiting embodiment of FIG. 1C, the integrated model 180 may include a first elastic layer 182, a second elastic layer 184, and a third elastic layer 186. Other integrated models may include few or lesser elastic layers. The inputs and outputs may be “wired” or “piped” together in virtually any combination. The arrangement of the inputs and outputs between the various elastic layers may define a hierarchical structure to the integrated model. The hierarchy may be adapted (either in real time or in a training mode) by re-arranging the wiring of the input and outputs between the various elastic layers. In the non-limiting embodiment shown in FIG. 1C, the three elastic layers are wired together in a cascading (or serial) fashion. Other arrangements are possible, for example various feedback loops may be generated by other arrangements of inputs and outputs between the elastic layers. The various elastic layers may be comprised of different model types. For example, the first elastic layer 182 may be keyword model, the second elastic layer 184 may be a key-phrase model, and the third elastic layer 186 may be a transformer-based model.

### Methods for Content Classification and Compliance Enforcement

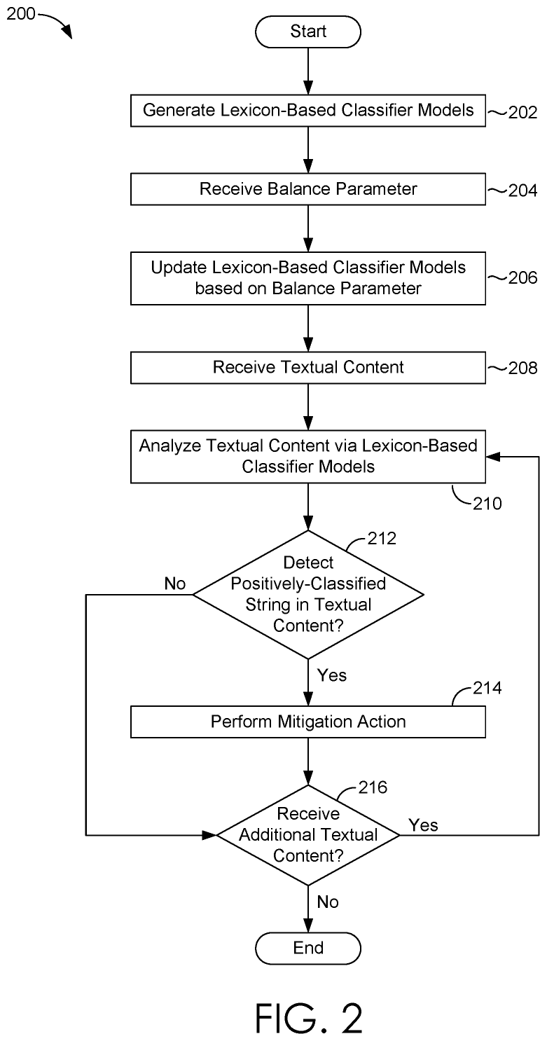

Turning to FIG. 2, a flow diagram is provided that illustrates a method 200 for content classification and enforcing compliance for one or more regulations, in accordance to the various embodiments. Generally, the flow diagram of FIG. 2 can be implemented using system 100 of FIG. 1A or any of the embodiments discussed throughout.

Initially, method 200 begins after a start block at block 202, where one or more lexicon-based classifier models are generated and/or trained. The training module 140 may be employed in generating and/or training the one or more classifier models. Various embodiments for generating and/or training lexicon-based classifier models are discussed throughout. At block 204, a balance parameter is received. For example, client device 102 or a system administrator may provide the balance parameter. At block 206, the one or more lexicon-based classifier models may be updated (e.g., “tuned”) based on the balance parameters. Various embodiments for updating and/or “tuning” a classifier model (e.g., one or more models based on lexicons 142) are discussed throughout. For instance, at least method 300 of FIG. 3A discuses a method of generating and/or training lexicon-based classifier models.

At block 208, input content (e.g., textual content) may be received. In some embodiments, the client device 102 may provide the textual content. At block 210, the textual content is analyzed via at least one of the one or more lexicon-based “tuned” classifier models. That is, at block 210, one or more strings in the textual content is classified into a “positive” or “negative” class via the classifier models. The classification module 120 may be employed to classify each string in the textual content. Each string may be either deterministically or probabilistically classified as a positive or negative example of the class.

At decision block 212, it is determined whether one or more strings have been positively classified. If one or more strings have been positively classified, method 200 may flow to block 214. If all the strings have been negatively classified, method 200 may flow to decision block 216. At block 214, one or more compliance interventions or mitigations may be performed. In some embodiments, the compliance enforcement module 130 may perform the one or more compliance interventions or mitigations. At decision block 216, it is determined whether additional content is received. If additional textual content is received at decision block 216, method 200 may return to block 210 to analyzed the additional textual content. If no additional content is received, method 200 may terminate.

### Methods for Generating, Training, and Tuning Lexicon-Based Classifier Model Training

Turning to FIG. 3A, a flow diagram is provided that illustrates a method 300 for generating lexicons for employment by a lexicon-based classifier model, in accordance to the various embodiments. Generally, the flow diagram of FIG. 3A can be implemented using system 100 of FIG. 1A or any of the embodiments discussed throughout. FIG. 3A will be discussed in conjunction with FIG. 3B and FIG. 3C. FIG. 3B shows a segmentation of labeled data into various datasets and lexicons, in accordance to various embodiments. FIG. 3C shows a generation of multiple lexicons, in accordance to various embodiments.

Method 300 begins, after a start block, at block 302 where a labeled dataset (e.g., labeled data 144) is received. The labeled dataset may include samples of text records. Each text record may include one or more character strings (e.g., keywords, key-phrases, sentences, sentence fragments, paragraphs, and the like). For example, each text record may include at least a portion of a document that includes textual content. Each text record (or string) may be labeled with one of two possible labels. The label for a string may be associated with a class or category (e.g., a class or category of a lexicon-based classifier model). For instance, a text record may be labeled with a “1” or “+” to indicate that the text record includes textual content that is classified as belonging to the “positive” class (e.g., associated with a binary classifier model), or the text record may be labeled with a “0” or “−” to indicate that the text record includes textual content that is classified as belonging to the “negative” class (e.g., associated with the binary classifier model).

At block 304, the labeled dataset is segmented into training data and test data. In some embodiments, the segmentation of the labeled data into training and test data includes a randomized 70/30 (training/test) split. In other embodiments, the random segmentation may include a 80/20 training/test split. The embodiments are not so constrained, and any appropriate segmentation of the labeled data may be employed. In FIG. 3B, the arrows 304 (to indicate the block 304 of method 300) illustrate the segmentation of labeled data 120 into training data 322 and test data 324. At block 306, the training data (e.g., training data 322) is further segmented into lexicon training data and score training data. In FIG. 3B, the arrows 306 (to indicate the block 306 of method 300) illustrate the segmentation of training data 322 into lexicon training data 326 and scoring threshold data 328. The lexicon training data 326 may be employed to train one or more lexicon-based classifier models, as discussed below. The scoring threshold data 328 may be employed to tune (or update) the lexicon-based classifier models based on a balance parameter (e.g., see block 206 of FIG. 2).

At block 308, the lexicon training data (e.g., lexicon training data 326) may be further segmented into positive lexicon training data and negative lexicon training data. In FIG. 3B, the arrows 308 (to indicate the block 308 of method 300) illustrate the segmentation of lexicon training data 326 into positive lexicon training data 330 and negative lexicon training data 332. The segmentation of lexicon training data (e.g., lexicon training data 326) into positive lexicon training data (e.g., positive lexicon training data 330) and negative lexicon training data (e.g., negative lexicon training data 332) may be based on the labeling of the text records included in the lexicon training data. For instance, the text records (included in the lexicon training data) that are labeled as belonging to the positive class may be included in the positive lexicon training data. The text records (included in the lexicon training data) that are labeled as belonging to the negative class may be included in the negative lexicon training data.

At block 310, character strings (e.g., keywords, key-phrases, sentences, sentence fragments, paragraphs, and the like) may be extracted from each of the positive lexicon training data and the negative lexicon training data. In addition to extracting strings (from the labeled text records include in the positive/negative lexicon training data 330/332), each string may be assigned one or more weights (e.g., probabilities and/or weights as discussed above in the conjunction with the definition of a lexicon). The assigned weigh may indicate the probability (e.g., degree of belief) that the string is associated with the positive or negative label (e.g., the label pertaining provided by the labeled text record). In some embodiments, one or more contextual labels may be associated with each extracted string. The contextual label may be determined from the context of which the string is employed in the text record. For instance, in some text records, the string “procure material” may be employed in a context indicated by the label “procurement contracts.” In other text records, the string may be employed in the context indicated by the label indicated by “bill of material.”

Each contextual label may be assigned a separate weight (or probability) for being associated with the positive or negative label associated with the text record that the string was extracted from. For example, the string “procure material” may be extracted from one or more text records labeled with the positive classification. As noted above, based on the one or more text records that the string was extracted from, the string may be associated with at least two contextual labels: “procurement contracts” and “bill of material.” The contextual label “procurement contracts” (for the string “procure material”) may be assigned a weight of 0.75 (e.g., a probability or degree of belief of 0.75 that the string “procure material” is associated with the positive label when the string is employed in the context of “procurement contracts”). The contextual label “bill of material” (for the string “bill of material”) may be assigned a weight of 0.25 (e.g., a probability or degree of belief of 0.25 that the string “procure material” is associated with the positive label when the string is employed in the context of “bill of material”).

In another non-limiting example, the string “the procurement contract should essentially have clauses to protect the contractor against any delays caused by vendor negligence” from one or more text records labeled with the positive category. The strong may be assigned four contextual labels: “procurement contract,” “clauses,” “delays,” and vendor negligence.” For the contextual label “clauses,” the string may be assigned a weight of 0.25. For the contextual label “delays,” the string may be assigned a weight of 0.20. For the contextual label “vendor negligence,” the string may be assigned a weight of 0.20. Note that is some embodiments, the sum of the weights for a string, over all of its associated contextual labels may be normalized to a value of 1.0.

In FIG. 3B, a string extractor and contextualizer module 334 is shown. The string extractor and contextualizer 334 may perform at least some of the actions associated with block 310. In some embodiments, the server device 104 of FIG. 1A may implement the string extractor and contextualizer module 334. The arrows 310 in FIG. 3B (to indicate the block 304 of method 300) illustrate the positive lexicon training data 330 and the negative lexicon training data 332 being provided as input to the string extractor and contextualizer module 334. At block 310, the string extractor and contextualizer module 334 may extract the strings from the text records, determine one or more contextual labels for each extracted string, and assign a weigh (or probability) to each contextual label for each extracted string. To perform such functionalities and/or operations, the string extractor and contextualizer module 334 may employ various methods to identify and/or select one or more contexts for a character string, based on the character and other character strings in the “neighborhood” of the character string within a textual-record.

At block 312, a positive lexicon and a negative lexicon may be generated from the strings extracted at block 310. In some embodiments, the strings that were extracted from text records labeled with the positive label may be included in the positive lexicon, while the strings extracted from text records labeled with the negative label may be included in the negative lexicon. Note that one or more strings may be included in both the positive and negative lexicons. In FIG. 3B, the arrows 312 (to indicate the block 312 of method 300) illustrate the generation of the positive lexicon 336 and the negative lexicon 338 from the extractions, contextual label assignments, and weight assignments of string extractor contextualizer module 334. Also in FIG. 3B, some example positive lexicon entries 340 are shown. More particular, positive lexicon entries 340 include an entry for the string “procure material,” and an entry for the string “the procurement contract should essentially have clauses to protect the contractor against any delays caused by vendor negligence.” In these examples, a string index has been assigned to each example entry, e.g., string index=1 has been assigned to string “procure material,” and string index=2 has been assigned to the string “the procurement contract should essentially have clauses to protect the contractor against any delays caused by vendor negligence.” Compound indices (e.g., 1_1, 1_2, 2_1, 2_2, 2_3, and 2_4) have also been assigned to each of the contextual labels (or string category) of each string, based on the string's index string.

At block 314, the intersection of the positive and negative lexicons are determined. The intersection of the positive and negative lexicons may include strings that are include in both the positive and negative lexicons. Because these strings are included in both the positive and negative lexicons, such strings may be referred to as uncertain lexicon entries (or strings). Additionally at block 314, the set differences of the positive and negative lexicons may be determined. The set difference Positive\Negative may include strings that are included in the positive lexicon but not included in the negative lexicon. Because these strings are only included in the positive lexicon, such strings may be referred to as pure positive lexicon entries (or strings). In contrast, the set difference Negative\Positive may include strings that are included in the negative lexicon but not included in the negative lexicon. Because these strings are only included in the negative lexicon, such strings may be referred to as pure negative lexicon entries (or strings).

FIG. 3C shows a graphical representation of the determining the intersection and set differences of the positive and negative lexicons, via Venn diagram 360. In Venn diagram 360, the circle (indicated as set A 362) represents the strings included in positive lexicon 336 and the circle (indicated as set B 364) represents the strings included in negative lexicon 338. The intersection of the positive lexicon 336 and the negative lexicon 338 is indicated by the uncertain entries 342. The set different AB is indicated by the pure positive entries 340. The set difference B/A is indicated by the pure negative entries.

At block 316, a pure positive lexicon may be generated to include the pure positive lexicon entries. Also at block 316, an uncertain lexicon may be generated to include the uncertain lexicon entries. At bloc 316, a pure negative lexicon may be generated to include the pure negative lexicon entries. The pure positive lexicon, the pure negative lexicon, and the uncertain lexicon may be generated based on the intersection and set differences of the positive and negative lexicons. FIG. 3C shows the pure positive lexicon 350 including the pure positive entries 340, the uncertain lexicon 352 including the uncertain entries 342, and the pure negative lexicon 354 including the pure negative entries 344. Generating the three pure positive, pure negative, and uncertain lexicons may reduce the noise that is included in the positive/negative lexicons.

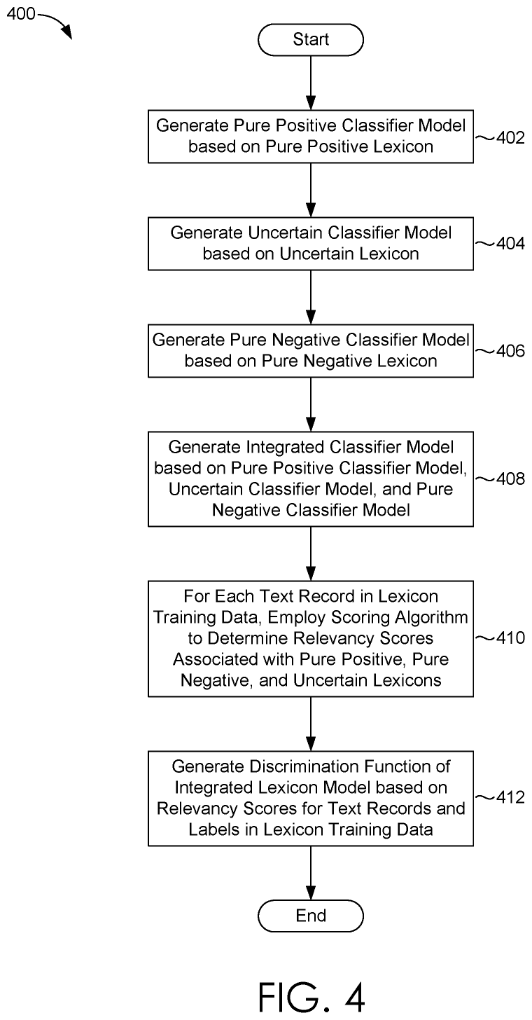

In some embodiments, the weights for pure positive, uncertain, and pure negative lexicon entries may be adjusted from the corresponding weights in the positive and negative lexicons. In a first embodiment for adjusting the weights of the lexicon entries, the weights for the uncertain entries (or strings) may be assigned to be equivalent to the average between the weights included in the corresponding entries in the positive and negative lexicons. The weights for the pure positive entries (or strings) and the pure negative entries may be assigned based on adjusting the weight in corresponding positive or negative lexicon entry in proportion to the separation of the weights in the positive and negative lexicons. In another method for assigning (or adjusting) the weights for the pure positive lexicon, pure negative lexicon, and uncertain lexicon, rather than creating mutually exclusive entries (that include separate weights) for the three lexicons, the weights for the strings may be adjusted based on the separation and/or margin in weights for each string as if the strings remained in the positive and/or negative lexicons. In still another method for assigning (or adjusting) the weights for the pure positive lexicon, pure negative lexicon, and uncertain lexicon, at least a portion of the uncertain strings may be included in the pure positive and/or pure negative lexicon. Considering an uncertain string that was included in both the positive and negative lexicon. If the separation of the sting's weights (between the positive and negative weights) is greater than a threshold margin, then the uncertain string may be included in each of the three lexicons. To adjust the weights of the common string in the three lexicons, the weight for the uncertain lexicon may be adjusted more significantly than the adjustments of the weights for the pure positive and pure negative lexicons. Method 300 may either terminate, or continue onto method 400 of FIG. 4.

Turning to FIG. 4, a flow diagram is provided that illustrates a method 400 for generating and training a lexicon-based classifier model, in accordance to the various embodiments. Generally, the flow diagram of FIG. 4 can be implemented using system 100 of FIG. 1A or any of the embodiments discussed throughout.

Method 400 begins, after a start block at block 402, where a pure positive (lexicon-based) classifier model is generated based on the pure positive lexicon generated via method 300. At block 404, an uncertain (lexicon-based) classifier model is generated based on the uncertain lexicon generated via method 300. At block 406, a pure negative (lexicon-based) classifier model is generated based on the pure negative lexicon generated via method 300. Various aspects of the following discussion may apply to each of the pure positive mode, the uncertain model, and pure negative lexicon models of blocks 402-406. For the following discussion, these three models may be collectively referred to as the models. Each of the models may be similar to string (e.g., keywords and/or key-phrases) lexicon-based classifier models (e.g., sentiment lexicon-based models). The models may generate (e.g., from unsupervised learning) one or more scores for an input string. Rather than using a single lexicon-based model as conventional inference-class probability models typically do, these three lexicon-based models may be employed in tandem to simultaneously improve both performance (recall (or true positive rate) and accuracy) and reliability (inverse of false positive rate).

At block 408, an integrated (lexicon-based) classifier model is generated based on the pure positive classifier model, the pure negative classifier model, and the uncertain classifier model. The integrated model may have the combination of all the knowledge included in the combination of the pure positive, uncertain, and pure negative models. That is, the knowledge of the integrated model may include the knowledge encoded in the combination of the pure positive lexicon, the uncertain lexicon, and the pure negative lexicon. Within the integrated model, each of the sub-models (e.g., the pure positive mode, the pure negative model, and the uncertain model) may be individually triggered, or a combination of the models may be triggered. The integrated model may be enable to determine when to trigger each. When triggered (e.g., via an input string), each of the sub-models may generate one or more scores, where the one or more scores indicate a binary classification, with respect to the sub-model. The integrated model is enabled to combine the one or more scores (generated by the one or more triggered sub-models) to generate a composite inference-probability (e.g., a composite score). Thus, the integrated model is compatible with existing model training and scoring pipelines that exists. In various embodiments, existing (e.g., conventional) classifier model pipelines may be retrofitted by replacing the model in the existing pipeline with the integrated model. Accordingly, the integrate model may provide higher performance and reliability as compared to convention models, while still being compatible with the conventional classifier pipelines. Additionally, the integrated model, includes additional attributes, such as tunable scoring-thresholds, ensemble-models, and other scoring and reconciliation logics, as discussed below.

Ay block 410, the lexicon training data (e.g., lexicon training data 308 of FIG. 3B) is employed to “train” the integrated model (and the sub-models). More specifically, for each text record in the lexicon training data, one or more scoring algorithms are employed to determine (or generate) one or more relevancy scores. Each of the one or more relevancy scores may be associated with at least one of the pure positive lexicon, the uncertain lexicon, or the pure negative lexicon. In some embodiments, at least one relevancy score may be determined for each of the three lexicons. More specifically, one or more scoring algorithms (e.g., metrics) may be employed to determine (e.g., compute) a relevance of an input candidate-string (the strings included in the text records of the lexicon training data) to one or more of lexicons (e.g., the pure positive lexicon, the uncertain lexicon, and/or the pure negative lexicon).

In some embodiments, each of the sub-models (e.g., the pure positive classifier model, the uncertain classifier model, and the pure negative classifier model) of the integrated model may receive each training textual record as input. Each of the sub-models may employ their associated (and underlying) lexicon to output one or more scores as described below. Note that the associated lexicons may be weighted lexicons, and the weights of the lexicons are employed to generate the one or more relevancy scores. In various embodiments, which and how many (and from which sub-model) of the computed scores are to be employed, could be manually determined or be automatically determined via the integrated model. Furthermore, thresholds scores may be determined via a balance parameter (as discussed in conjunction with method 500) for each score and retained the integrated model.

In some embodiments, an “overlap term list” scoring algorithms may be employed at block 410. Such overlap term list scoring algorithms may be similar to the methods described in conjunction with blocks 310, 312, 314, and 316 of method 300 of FIG. 3A. However, briefly here, similar to blocks 310 and 312, a lexicon (e.g., a context-aware lexicon, as discussed above) may be extracted from the input text. Then, similar to block 314 and 316, an intersection of the lexicon (e.g., an intersection lexicon) may be determined from candidate text and the individual lexicons from the classifier sub-models (e.g., the pure positive model, the pure negative model, and the uncertain model). A list of overlap strings (e.g., the overlap term list such as the uncertain entries 342 of FIG. 3C) may be generated to include the strings extracted from this intersection lexicon. The list of overlap strings may be referred to as the intersection lexicon. In some embodiments, the list of overlap strings may not include the metadata (that is encoded in the lexicons). In other embodiments, the list of overlap strings may include the metadata for the strings. In other embodiments, rather than generating an intersection of strings, all the strings (e.g., terms) from the input text may be extracted. The lexicon generated from all the extracted strings may be referred to as the all terms lexicon.

In some embodiments, an aggregation (e.g., a sum or average) of the weights of the intersection lexicon may be generated. The weights may be the weights as they existed in candidate text lexicon (e.g., not the weights included in the model lexicon). The weights may be normalized weights (e.g., the weights are divided by total terms-count/weight of the intersection lexicon) or absolute weights. Such a lexicon may be referred to as a match string weight lexicon. In still other embodiments, the weights from the strings in the intersection are aggregated corresponding to how the strings exists in the sub-model's lexicon (e.g., the pure positive lexicon, the pure negative lexicon, or the uncertain lexicon). Similar to the match string weight lexicon, these embodiments may be weights by the sub-model's lexicon's weights and/or sizes.

At block 412, a discrimination function of the integrated lexicon model may be generated. That is, a function is generated, where the function determines (or dictates) how to use the relevancy scores (from block 410) to discriminate (or identify) positive samples from negatives. In some embodiments, a hierarchical scoring process is employed in the generation of the discrimination function. In other embodiments, an ensemble scoring process is employed in the generation of the discrimination function.

Such hierarchical scoring embodiments may employ one or more hierarchical scoring processes. In some embodiments, a hierarchical scoring process may include triggering each of the pure positive model, the pure negative model, and the uncertain model based on a predetermined hierarchy. The specifics of the predetermined hierarchy may be determined based on the constraints that are to be optimized for the classifier. For example, conditions where reliability (e.g., low FPR) is important, the order of filtration of lexicons in the hierarchy is: the pure negative lexicon, the uncertain lexicon, and then the pure positive lexicon. That is, first the pure negative sub-model is triggered first to screen/filter “pure negative” strings. Then, the uncertain sub-model is triggered, and finally the pure positive sub-model is triggered. Therefore, for minimizing-FPR as a goal (as indicated by a balance parameter), first any candidate-string is filtered (or removed) that are screened as negative (i.e., positive (or having high scores) by the pure negative sub-model) are filtered or removed. After removal of “pure negative” strings (e.g., strings that have entries in the pure negative lexicon), “uncertain” strings (e.g., stings that have entries in the uncertain lexicon) are next screened. These strings that are screened/filtered via the uncertain lexicon need not be eliminated but could be routed to another model/algorithm. As indicated, at the bottom of the hierarchy, the pure positive model is finally triggered after triggering the pure negative and the uncertain sub-models. Upon triggering the pure positive sub-model, the “pure positive” candidate-strings (e.g., strings that receive a high score (e.g., above a threshold) by the pure positive sub-model) are termed as positive. The probability of positive could be determined either exclusively from the pure positive model, or be a combination of probability, as derived from each of the pure positive, pure negative, and uncertain sub-models.

Ensemble scoring embodiments may employ one or more ensemble scoring processes. In some embodiments, an ensemble scoring process may employ an additional (ancillary/ensemble) model. This additional model may be included in the integrated classifier model. In such ensemble scoring processes, a consolidated vector of all scores from all individual sub-models (the pure positive, the pure negative, and the uncertain sub-models) is used as input to train another classification model (classification models that work on structured data). This additional classifier model may be employed during training to learn a function on the score vector to predict a class and respective class probability, that is used for output. Further models based on margin-maximization (e.g., support vector machines) could be employed if there is an alternate approach available whenever separation margin criteria are not met, or otherwise the prediction probability is not high

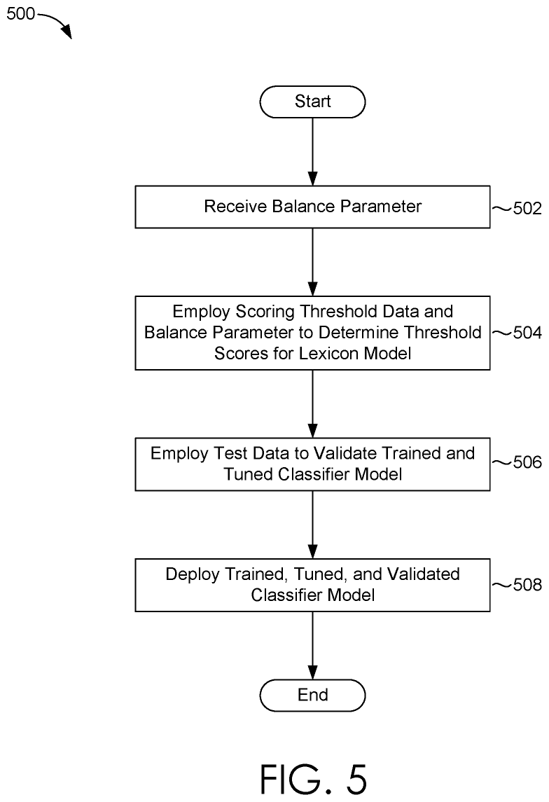

Whether hierarchical or ensemble scoring processes (or methods) are employed, the scores of block 410 are employed to obtain either score-thresholds. For hierarchy scoring embodiments, the score thresholds may be based on hierarchy/order of using different individual models. In ensemble scoring embodiments, the scoring thresholds may be based on employing a supervised model to learn the discrimination (or separation) function based on these scores. Method 400 may terminate or flow to method 500 of FIG. 5.

Turning to FIG. 5, a flow diagram is provided that illustrates a method 500 for tuning a lexicon-based classifier model, in accordance to the various embodiments. Generally, the flow diagram of FIG. 5 can be implemented using system 100 of FIG. 1A or any of the embodiments discussed throughout.

Method 500 begins, after a start block at block 502, where a balance parameter is received. Receiving a balance parameter at block 502 may be similar to receiving a balance parameter at block 204 of method 200 of FIG. 2. At block 504, scoring threshold data (e.g., scoring threshold data 328 of FIG. 3B) and the balance parameter may be employed to determine threshold scores (for the discrimination function) for the integrated lexicon model. As discussed in conjunction with block 412 of method 400, in some embodiments, a hierarchical scoring method is employed, while in other embodiments, an ensemble scoring method is employed.

At block 506, test data (e.g., test data 324 of FIG. 3B) may be employed to test and/or validate the trained and tuned lexicon-based classifier model. In some embodiments, the test data is employed to evaluate the performance of the complete classifier model. This performance evaluation may be performed in a standardized setting such that it is comparable to that of other competing models. Therefore, the same test set may be employed to evaluate other competing models.

### Other Embodiments

One embodiment includes receiving text-based content. An integrated classifier may be employed to classify the text-based content as belonging to a positive class of the integrated classifier model. The integrated classifier model may include a first sub-model based on a first lexicon, a second sub-model based on a second lexicon, and a third sub-model based on a third lexicon. The first lexicon may include a first plurality of strings that are included a first plurality of training records that are labeled as belonging to the positive class of the classifier model. The second lexicon may include a second plurality of strings that are included in a second plurality of training records that are labeled as belonging to a negative class of the classifier model. The third lexicon may include a third plurality of strings that are included in both the first plurality of training records and the second plurality of training records. In response to classifying the text-based content as belonging to the positive class of the classifier model, one or more mitigation actions that alters subsequent transmissions of the text-based content may be performed. The one or more mitigation actions may include at least one of providing an alter indicating the text-based content, deleting the text-based content, replacing the text-based content, or quarantining the text-based content.

In some embodiments, a balance parameter may be received. The balance parameter may indicates a target (e.g., a predetermined and/or desired) tradeoff between a false positive error rate (FPR) of the classifier model and a false negative error rate (FNR) of the classifier model. The balance parameter may be employed to update the classifier model such that the updated classifier model, when benchmarked against a third plurality of training records, exhibits the target tradeoff between the FPR of the classifier model and the FNR of the classifier. The updated classifier model may be employed to classify the text-based content as belonging to a positive class of the classifier model.

In various embodiments, each record of the third plurality of training records may include a label that indicates that the record belongs to either the positive class or the negative class of the classifier model. Employing the balance parameter to update the classifier model may include iteratively employing one or more threshold parameters of the classifier model to determine a classification of each record of the third plurality of training records. The label and the classification of each record of the third plurality of records may be iteratively employed to determine each of the FPR and the FNR of the classifier model. The one or more threshold parameters of the classifier model may be iteratively adjusted such that the classifier model, when benchmarked against the third plurality of training records, exhibits the target tradeoff between the FPR of the classifier model and the FNR of the classifier model.

In various embodiments, classifying the text-based content may include employing the first sub-model to determine a first score for the text-based content. The first score may indicate a likelihood that the text-based content is associated with the positive class of the classifier model. The second sub-model may be employed to determine a second score for the text-based content. The second score may indicate a likelihood that the text-based content is associated with the negative class of the classifier model. The third sub-model may be employed to determine a third score for the text-based content. The third score may indicate a likelihood that the text-based content is associated with both the positive class of the classifier model and the negative class of the classifier model. The classifier model may be employed to generate an overall score for the text-based content. The overall score for the text-based content may be based on a combination of the first score, the second score, and the third score for the text-based content. The overall score for the text-based content may indicate an overall likelihood that the text-based content is associated with the positive class of the classifier model. The text-based content may be classified as belonging to the positive class of the classifier model based on the overall score for the text-based content and a discrimination function of the classifier model. In some embodiments, a hierarchical scoring process is employed to determine at least one of the first score, the second score, the third score, or the overall score for the text-based content. In other embodiments, an ensemble scoring process is employed to determine at least one of the first score, the second score, the third score, or the overall score for the text-based content.

Other embodiments may include generating a first sub-model of the classifier model based on a first lexicon. The first lexicon may include a first plurality of strings. The first plurality of strings may be included a first plurality of training records. Each of the records of the first plurality of training record may include label that indicates that the record belongs to the positive class. A second sub-model of the classifier model may be generated based on a second lexicon. The second lexicon may include a second plurality of strings. The second plurality of strings may be included in a second plurality of training records. Each record of the second plurality of records may include a label that indicates that the record that the record belongs to a negative class of the classifier model. A third sub-model of the classifier model may be generated. Generating the third sub-model may be based on a third lexicon. The third lexicon may include a third plurality of strings. The third plurality of strings may be included in both the first plurality of training records and the second plurality of training records. The first sub-model, the second sub-model, and the third sub-model may be integrated to generate the classifier model.

In various embodiments, a fourth lexicon may be generated based on the first plurality of training records. A fifth lexicon may be based on the second plurality of training records. The first, second, and third lexicons may be generated based on the fourth lexicon and the fifth lexicon. More specifically, an intersection of the fourth and fifth lexicons may be determined. The third lexicon may be generated to include the determined intersection of the fourth and fifth lexicons. A set difference between the fourth and fifth lexicons may be determined. The first lexicon may be generated to include the determined set difference between the fourth and fifth lexicons. A set difference between the fifth and fourth lexicons may be determined. The second lexicon may be generated to include the determined set difference between the fifth and fourth lexicons.

In various embodiments, labeled archived data (e.g., labeled training data) may be accessed. The labeled archived data may be segmented into a set of testing data and a set of training data. The training data may be segmented, based on the labels included in the set of training data, into the first plurality of training records and the second plurality of training records. The labeled testing data may be employed to validate the classifier model. The set of training data may be employed to train the classifier model. In various embodiments, the set of training data may be segmented into a set of lexicon training data and a set of scoring threshold data. The set of lexicon training data may be segmented into the first plurality of training records and the second plurality of training records. The classifier model may be updated such that the updated classifier model, when benchmarked against the set of scoring threshold data, exhibits a predetermined (or target) tradeoff between a false positive error rate (FPR) and a false negative error rate (FNR) of the classifier model. The generated, trained, and updated (e.g., tuned) classifier model may be deployed in a compliance enforcement pipeline.

### Generalized Computing Device

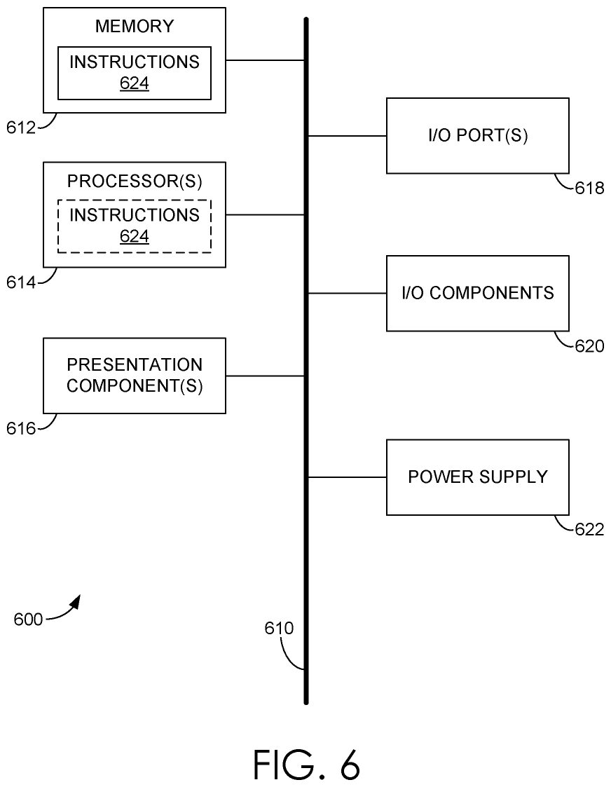

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. Bus 610 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 6 and with reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors 614 that read data from various entities such as memory 612 or I/O components 620. Presentation component(s) 616 presents data indications to a user or other device. In some implementations, presentation component 220 of system 200 may be embodied as a presentation component 616. Other examples of presentation components may include a display device, speaker, printing component, vibrating component, and the like.

The I/O ports 618 allow computing device 600 to be logically coupled to other devices, including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Some embodiments of computing device 600 may include one or more radio(s) 624 (or similar wireless communication components). The radio 624 transmits and receives radio or wireless communications. The computing device 600 may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

With reference to the technical solution environment described herein, embodiments described herein support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the system components can manage resources and provide services for system functionality. Any other variations and combinations thereof are contemplated with embodiments of the present disclosure.

By way of example, the technical solution system can include an Application Programming Interface (API) library that includes specifications for routines, data structures, object classes, and variables may support the interaction between the hardware architecture of the device and the software framework of the technical solution system. These APIs include configuration specifications for the technical solution system such that the different components therein can communicate with each other in the technical solution system, as described herein.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present disclosure are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

Embodiments of the present disclosure have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computer-implemented method for compliance enforcement, the method comprising:
receiving text-based content;
classifying the text-based content as belonging to a positive class of an integrated classifier model that includes a first sub-model based on a first lexicon, a second sub-model based on a second lexicon, and a third sub-model based on a third lexicon, wherein the first lexicon includes a first plurality of strings that are included in a first plurality of training records that are labeled as belonging to the positive class of the classifier model, the second lexicon includes a second plurality of strings that are included in a second plurality of training records that are labeled as belonging to a negative class of the classifier model, and the third lexicon includes a third plurality of strings that are included in both the first plurality of training records and the second plurality of training records; and
in response to classifying the text-based content as belonging to the positive class of the classifier model, performing one or more mitigation actions that alters subsequent transmissions of the text-based content.

2. The method of claim 1, wherein the method further comprises:
receiving a balance parameter that indicates a target tradeoff between a false positive error rate (FPR) of the classifier model and a false negative error rate (FNR) of the classifier model;
employing the balance parameter to update the classifier model such that the updated classifier model, when benchmarked against a third plurality of training records, exhibits the target tradeoff between the FPR of the classifier model and the FNR of the classifier; and
employing the updated classifier model to classify the text-based content as belonging to a positive class of the classifier model.

3. The method of claim 2, wherein each record of the third plurality of training records includes a label that indicates that the record belongs to either the positive class or the negative class of the classifier model and employing the balance parameter to update the classifier model comprises:
iteratively employing one or more threshold parameters of the classifier model to determine a classification of each record of the third plurality of training records;
iteratively employing the label and the classification of each record of the third plurality of records to determine each of the FPR and the FNR of the classifier model; and
iteratively adjusting the one or more threshold parameters of the classifier model such that the classifier model, when benchmarked against the third plurality of training records, exhibits the target tradeoff between the FPR of the classifier model and the FNR of the classifier model.

4. The method of claim 1, wherein classifying the text-based content comprises:
employing the first sub-model to determine a first score for the text-based content, wherein the first score indicates a likelihood that the text-based content is associated with the positive class of the classifier model;
employing the second sub-model to determine a second score for the text-based content, wherein the second score indicates a likelihood that the text-based content is associated with the negative class of the classifier model;
employing the third sub-model to determine a third score for the text-based content, wherein the third score indicates a likelihood that the text-based content is associated with both the positive class of the classifier model and the negative class of the classifier model;
employing the classifier model to generate an overall score for the text-based content that is based on a combination of the first score, the second score, and the third score for the text-based content, wherein the overall score indicates an overall likelihood that the text-based content is associated with the positive class of the classifier model; and
classifying the text-based content as belonging to the positive class of the classifier model based on the overall score for the text-based content and a discrimination function of the classifier model.

5. The method of claim 4, wherein a hierarchical scoring process is employed to determine at least one of the first score, the second score, the third score, or the overall score for the text-based content.

6. The method of claim 4, wherein an ensemble scoring process is employed to determine at least one of the first score, the second score, the third score, or the overall score for the text-based content.

7. The method of claim 1, wherein the one or more mitigation actions includes at least one of providing an alter indicating the text-based content, deleting the text-based content, replacing the text-based content, or quarantining the text-based content.

8. A system for generating an integrated classifier model that has a positive class and a negative class, the system comprising:
one or more hardware processors; and
one or more computer-readable media having executable instructions embodied thereon, which, when executed by the one or more processors, cause the one or more hardware processors to execute actions comprising:
generating a first sub-model of the classifier model based on a first lexicon that includes a first plurality of strings that are included in a first plurality of training records that are labeled as belonging to the positive class;
generating a second sub-model of the classifier model based on a second lexicon that includes a second plurality of strings that are included in a second plurality of training records that are labeled as belonging to the negative class;
generating a third sub-model of the classifier model based on a third lexicon that includes a third plurality of strings that are included in both the first plurality of training records and the second plurality of training records; and
integrating the first sub-model, the second sub-model, and the third sub-model to generate the classifier model.

9. The system of claim 8, wherein the actions further comprise:
generating a fourth lexicon based on the first plurality of training records;
generating a fifth lexicon based on the second plurality of training records; and
generating the first, second, and third lexicons based on the fourth lexicon and the fifth lexicon.

10. The system of claim 9, wherein the actions further comprise:
determining an intersection of the fourth and fifth lexicons;
determining a set difference of the fourth and fifth lexicons;
determining a set difference of the fifth and fourth lexicons;
generating the first lexicon to include the determined set difference of the fourth and fifth lexicons;
generating the second lexicon to include the determined set difference of the fifth and fourth lexicons; and
generating the third lexicon to include the determined intersection of the fourth and fifth lexicons.

11. The system of claim 8, wherein the actions further comprise:
accessing labeled archived data;
segmenting the labeled archived data into a set of testing data and a set of training data;
segmenting the training data, based on the labels included in the set of training data, into the first plurality of training records and the second plurality of training records; and
employing the labeled testing data to validate the classifier model.

12. The system of claim 11, wherein the actions further comprise:
employing the set of training data to train the classifier model.

13. The system of claim 11, wherein the actions further comprise:
segmenting the set of training data into a set of lexicon training data and a set of scoring threshold data;
segmenting the set of lexicon training data into the first plurality of training records and the second plurality of training records; and
updating the classifier model such that the updated classifier model, when benchmarked against the set of scoring threshold data, exhibits a predetermined tradeoff between a false positive error rate (FPR) and a false negative error rate (FNR) of the classifier model.

14. The system of claim 8, wherein the actions further comprise:
receiving a balance parameter that indicates a target tradeoff between a false positive error rate (FPR) of the classifier model and a false negative error rate (FNR) of the classifier model; and
employing the balance parameter to update the classifier model such that the updated classifier model, when benchmarked against a third plurality of training records, exhibits the target tradeoff between the FPR of the classifier model and the FNR of the classifier; and
employing the tuned classifier model to classify the text-based content as belonging to a positive class of the classifier model.

15. The system of claim 14, wherein each record of the third plurality of training records includes a label that indicates that the record belongs to either to the positive class or the negative class of the classifier model and employing the balance parameter to update the classifier model comprises:
iteratively employing one or more threshold parameters of the classifier model to determine a classification of each record of the third plurality of training records;
iteratively employing the label and the classification of each record of the third plurality of records to determine each of the FPR and the FNR of the classifier model; and
iteratively adjusting the one or more threshold parameters of the classifier model such that the classifier model, when benchmarked against the third plurality of training records, exhibits the indicated tradeoff between the FPR of the classifier model and the FNR of the classifier model.

16. The system of claim 8, wherein the actions further comprise:
deploying the classifier model in a compliance enforcement pipeline.

17. One or more computer storage media storing computer-useable instructions that, when used by one or more computing devices, cause the one or more computing devices to perform actions comprising:
generating a first sub-model of the classifier model based on a first lexicon that includes a first plurality of strings that are included in a first plurality of training records that are labeled as belonging to the positive class;
generating a second sub-model of the classifier model based on a second lexicon that includes a second plurality of strings that are included in a second plurality of training records that are labeled as belonging to the negative class;
generating a third sub-model of the classifier model based on a third lexicon that includes a third plurality of strings that are included in both the first plurality of training records and the second plurality of training records; and
integrating the first sub-model, the second sub-model, and the third sub-model to generate the classifier model.

19. The media of claim 18, wherein the actions further comprise:
receiving text-based content;
employing the classifier model to classify the text-based content as belonging to the positive class; and
in response to classifying the text-based content as belonging to the positive class of the classifier model, performing one or more mitigation actions that alters subsequent transmissions of the text-based content.

20. The media of claim 18, wherein the actions further comprise:
receiving a balance parameter that indicates a target tradeoff between a false positive error rate (FPR) of the classifier model and a false negative error rate (FNR) of the classifier model;
employing the balance parameter to update the classifier model such that the updated classifier model, when benchmarked against a third plurality of training records, exhibits the target tradeoff between the FPR of the classifier model and the FNR of the classifier; and
employing the tuned classifier model to classify the text-based content as belonging to a positive class of the classifier model.
